(19) United States
(12) Patent Application Publication
(10) Pub. No.: US 2017/0017309 A1
(43) Pub. Date: Jan. 19, 2017

(54) IMAGE PROJECTION APPARATUS, IMAGE PROJECTION SYSTEM, DISPLAY APPARATUS, AND DISPLAY SYSTEM FOR ILLUMINATING INDICATION LIGHT

(71) Applicant: CANON KABUSHIKI KAISHA, Tokyo (JP)

(72) Inventor: Yoshiyuki Okada, Sakura-shi (JP)

(21) Appl. No.: 15/205,339

(22) Filed: Jul. 8, 2016

(30) Foreign Application Priority Data
Jul. 13, 2015 (JP) 2015-139550

(51) Int. Cl. G06F 3/03; H04N 9/31; G06F 3/0354

(52) U.S. Cl. CPC G06F 3/0304; G06F 3/03545; H04N 9/3182; H04N 9/312

(57) ABSTRACT

An image projection apparatus includes an input unit that inputs an image signal, an image processor that performs image processing on the image signal, an optical unit that generates an image based on a signal output from the image processor by using light from a light source unit, and a projection unit that projects the image as a projected image onto a projected surface, and the image processor performs the image processing so that an image indicating an illumination position of indication light from an indicator on the projected surface as an indication signal indicating the illumination position of the indication light and an image obtained based on the image signal are separated from each other on the projected surface based on imaging data of the projected image obtained while the indication light from the indicator is illuminated onto the projected surface.

### BACKGROUND OF THE INVENTION

Field of the Invention

The present invention relates to an image projection apparatus that illuminates indication light onto an arbitrary position on a projected image through an indicator.

Description of the Related Art

Conventionally, in a conference or a presentation using an image projection apparatus such as a projector, a laser pointer is used to explain a projected image in some cases. However, it may be difficult to identify indication light illuminated by the laser pointer depending on brightness of the projected image or a background color. Furthermore, the indication light is extremely small compared with a size of a screen and the indication is instantaneous, and accordingly it is relatively difficult to identify the indication light.

Japanese Patent Laid-open No. 2004-110797 discloses an indicated position detecting apparatus that detects an illumination position of indication light illuminated through a pointing device such as a laser pointer. This indicated position detecting apparatus illuminates R (red), G (green), and B (blue) as three primary colors of light separately in time division. When the color of the laser pointer is R (red), the indicated position detecting apparatus takes an image at the timing while G (green) and B (blue) are projected, and it detects the illumination position of the indication light by considering R (red) in imaging data as the laser pointer.

Japanese Patent Laid-open No. 2004-118807 discloses a projector that detects a position of indication light illuminated through a laser pointer by using an image pickup unit and that reprojects a characteristic color (hue) or symbol in accordance with the position. This projector sets a wavelength of light of the laser pointer to be different from a wavelength of a projected image, and the image pickup unit is provided with a filter through which only the wavelength of the light of the laser pointer transmits, and thus an influence on the projected image is suppressed.

However, in the configuration disclosed in Japanese Patent Laid-open No. 2004-110797, it is difficult for audiences seeing the screen to identify the position of the indication light if colors of the projected image and the indication light illuminated through the laser pointer are similar to each other. Japanese Patent Laid-open No. 2004-118807 does not specifically describe the color or the symbol of the reprojection according to the position of the indication light. Therefore, it is difficult for the audiences seeing the screen to identify the reprojected color or symbol according to the position of the indication light.

### SUMMARY OF THE INVENTION

The present invention provides an image projection apparatus, an image projection system, a display apparatus, and a display system which are capable of easily identifying a position of indication light illuminated by an indicator.

An image projection apparatus as one aspect of the present invention includes an input unit configured to input an image signal, an image processor configured to perform image processing on the image signal, an optical unit configured to generate an image based on a signal output from the image processor by using light from a light source unit, and a projection unit configured to project the image as a projected image onto a projected surface, and the image processor is configured to perform the image processing so that an image indicating an illumination position of indication light from an indicator on the projected surface as an indication signal indicating the illumination position of the indication light and an image obtained based on the image signal are separated from each other on the projected surface based on imaging data of the projected image obtained while the indication light from the indicator is illuminated onto the projected surface.

An image projection system as another aspect of the present invention includes an input unit configured to input an image signal, an image processor configured to perform image processing on the image signal, an optical unit configured to generate an image based on a signal output from the image processor by using light from a light source unit, and a projection unit configured to project the image as a projected image onto a projected surface, an indicator configured to illuminate indication light onto the projected surface, and an image pickup unit configured to acquire imaging data of the projected image while the indication light is illuminated onto the projected surface, and the image processor is configured to perform the image processing so that an image indicating an illumination position of indication light from an indicator on the projected surface as an indication signal indicating the illumination position of the indication light and an image obtained based on the image signal are separated from each other on the projected surface.

A display apparatus as another aspect of the present invention includes an input unit configured to input an image signal, an image processor configured to perform image processing on the image signal, and a display unit configured to display an image on a displayed surface based on a signal output from the image processor, and the image processor is configured to perform the image processing so that an image indicating an illumination position of indication light from an indicator on the displayed surface as an indication signal indicating the illumination position of the indication light and an image obtained based on the image signal are separated from each other on the displayed surface based on imaging data of the projected image obtained while the indication light from the indicator is illuminated onto the displayed surface.

A display system as another aspect of the present invention includes an input unit configured to input an image signal, an image processor configured to perform image processing on the image signal, and a display unit configured to display an image on a displayed surface based on a signal output from the image processor, an indicator configured to illuminate indication light onto the displayed surface, and an image pickup unit configured to acquire imaging data of the image while the indication light is illuminated onto the displayed surface, and the image processor is configured to perform the image processing so that an image indicating an illumination position of indication light from an indicator on the displayed surface as an indication signal indicating the illumination position of the indication light and an image obtained based on the image signal are separated from each other on the displayed surface based on the imaging data.

Further features of the present invention will become apparent from the following description of exemplary embodiments with reference to the attached drawings.

### BRIEF DESCRIPTION OF THE DRAWINGS

FIG. 1 is a configuration diagram of an image projection system in Embodiment 1.

FIG. 2 is a side view of an image projection apparatus in Embodiment 1.

FIG. 3 is an explanatory diagram of a pointer registration in Embodiment 1.

FIG. 4 is a block diagram of the image projection apparatus in Embodiment 1.

FIG. 5 is a block diagram of an image processor in Embodiment 1.

FIG. 6 is a flowchart of illustrating processing by the image projection apparatus in Embodiment 1.

FIG. 7 is a block diagram of an image processor in Embodiment 2.

FIG. 8 is a flowchart of illustrating processing by the image projection apparatus in Embodiment 2.

FIG. 9 is a block diagram of an image processor in Embodiment 3.

FIG. 10 is a block diagram of an image processor in Embodiment 4.

FIG. 11 is a block diagram of a display apparatus in Embodiment 5.

### DESCRIPTION OF THE EMBODIMENTS

Exemplary embodiments of the present invention will be described below with reference to the accompanied drawings.

### Embodiment 1

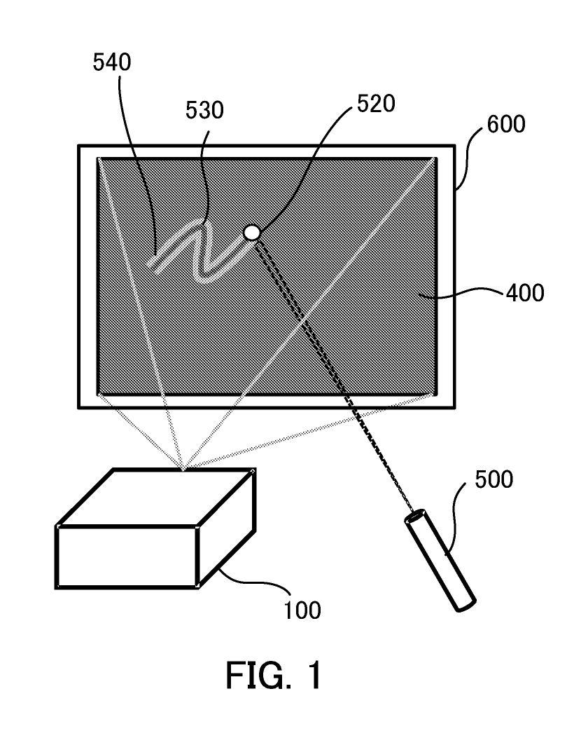

First, referring to FIG. 1, an image projection system in Embodiment 1 of the present invention will be described. FIG. 1 is a configuration diagram of the image projection system in this embodiment. An image projection apparatus 100 (projector) projects a projected image 400 onto a projected surface 600 such as a screen. A pointer 500 (indicator) illuminates point light (indication light) onto an arbitrary position (pointer illumination position 520) on the projected image 400 based on an operation by a user. The pointer 500 is a non-visible laser pointer or a non-visible light LED using non-visible light such as infrared light, but it is not limited thereto. In this embodiment, the image projection apparatus 100 displays a pointer locus 530 that corresponds to a locus of the pointer illumination position 520 illuminated by the pointer 500 and an edge line 540 that edges the pointer locus 530 on the projected image 400. The detail will be described below.

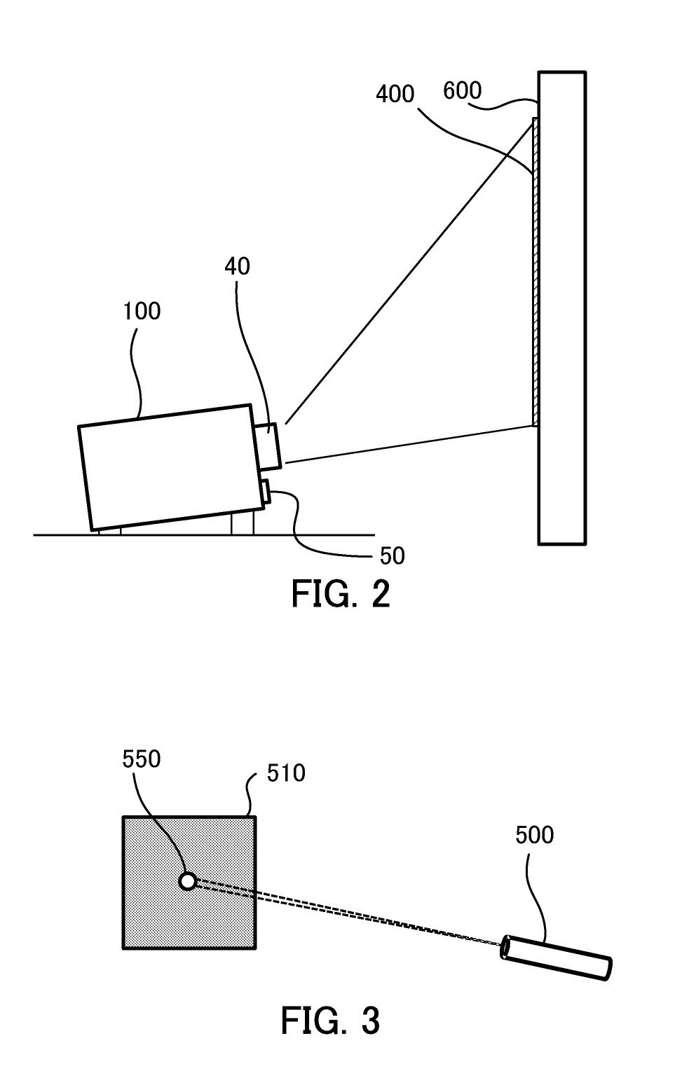

Next, referring to FIG. 2, an external configuration of the image projection apparatus 100 will be described. FIG. 2 is a side view of the image projection apparatus 100. The image projection apparatus 100 includes the projection unit 40 and the image pickup unit 50 on a front surface of the image projection apparatus 100. The image projection unit 40 projects the projected image 400 on the projected surface 600. The image pickup unit 50 takes the projected image 400 (projected surface 600). Particularly, in this embodiment, the image pickup unit 50 acquires the imaging data of the projected image 400 while the indication light is illuminated onto the projected surface 600. In this embodiment, the image pickup unit 50 is provided inside the image projection apparatus 100, but this embodiment is not limited thereto. For example, the image pickup unit 50 may be provided outside the image projection apparatus 100 such that the image pickup unit 50 is attached to the image projection apparatus 100. The image pickup unit 50 is not necessarily provided to be integrated with the image projection apparatus 100, but the image pickup unit 50 may be provided separately from the image projection apparatus 100 (i.e., located at a distance from the image projection apparatus 100). The installation location of the image pickup unit 50 is not limited as long as it is capable of taking the projected image 400. For example, in FIG. 2, the image pickup unit 50 is provided on a lower position relative to the projection unit 40 on the front surface of the image projection apparatus 100, but the image pickup unit 50 is not limited thereto and it may be provided at another position as long as it is capable of taking the projected image 400.

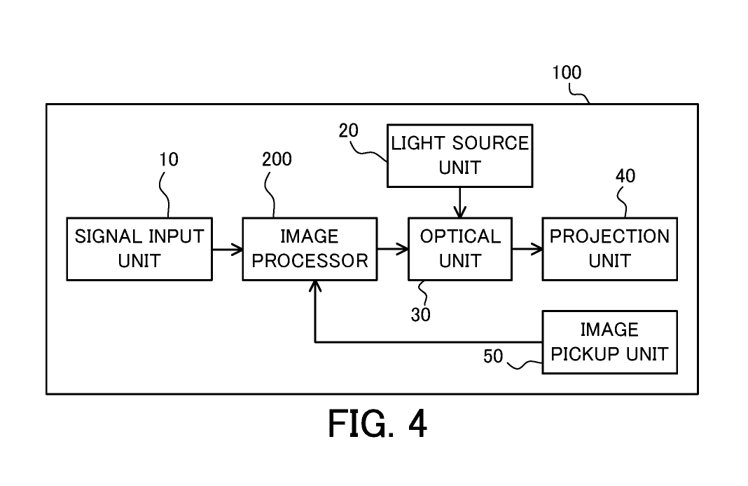

Next, referring to FIG. 4, a configuration of the image projection apparatus 100 will be described. FIG. 4 is a block diagram of the image projection apparatus 100. The image projection apparatus 100 includes a signal input unit 10, a light source unit 20, an optical unit 30, a projection unit 40, an image pickup unit 50, and an image processor 200.

The signal input unit 10 (input unit or input circuit) is an input interface that is connected with an external apparatus such as a computer and a media player to input an image signal (video signal). It is preferred that the signal input unit 10 is compatible with image signals of various standards. For example, it may be compatible with digital interface standards such as HDMI, DisplayPort, USB, HDBaseT, Ethernet, and DVI, analog interface standards such as VGA, D-Terminal, S-Terminal, and wireless LAN such as Wi-Fi. More preferably, the signal input unit 10 is compatible with a low-speed interface signal such as RS232C.

The image processor 200 (image processing circuit) is a processor that performs various image processing on the image signal from the signal input unit 10. The detail of the image processor 200 will be described below. The light source unit 20 is a light emitting unit including a light source such as a lamp, an LED, and a laser. The optical unit 30 (optical device) generates an image (color image) from a signal output from the image processor 200 by using light emitted from the light source unit 20. For example, the optical unit 30 includes an optical modulation element such as a transmission liquid crystal panel, a reflection liquid crystal panel, and a reflection mirror panel called a DMD (Digital Mirror Device). The optical unit 30 splits the light emitted from the light source unit 20 into three primary color lights, performs intensity modulation on each primary color light based on the signal from the image processor 200, and resynthesizes the modulated three primary color lights. The projection unit 40 (projection device) magnifies an image generated by the optical unit 30 to project the magnified image as the projected image 400 onto the projected surface 600.

The image pickup unit 50 includes an image pickup device such as a CCD (Charge Coupled Device) image sensor and a CMOS (Complementary MOS) image sensor. When the pointer 500 is an infrared light pointer as a non-visible laser light pointer or a non-visible light LED pointer, the image pickup unit 50 is capable of taking infrared light. For example, the image pickup unit 50 may be provided with a camera exclusively used for the infrared light, or it maybe configured to dispose an optical filter in front of the image pickup device to cut non-visible light off such that the infrared light transmits to be taken. As described above, the image pickup unit 50 only takes the non-visible light without taking visible light, and accordingly it is capable of taking only the non-visible light (non-visible point light) illuminated by the pointer 500. The image pickup unit 50 can be configured to take an image (non-visible light) based on a timing signal output from the image processor 200. The image pickup unit 50 may send imaging data that are taken at the timing determined inside the image pickup unit 50 to the image processor 200. In this embodiment, an imaging rate of the image pickup unit 50 is for example around 30 frames/sec. When a velocity of the motion of the pointer 500 is slow, the imaging rate may be around several frames/sec. On the other hand, when the velocity of the motion of the pointer 500 is fast, the imaging rate can be set up to dozens frames/sec or hundreds frames/sec.

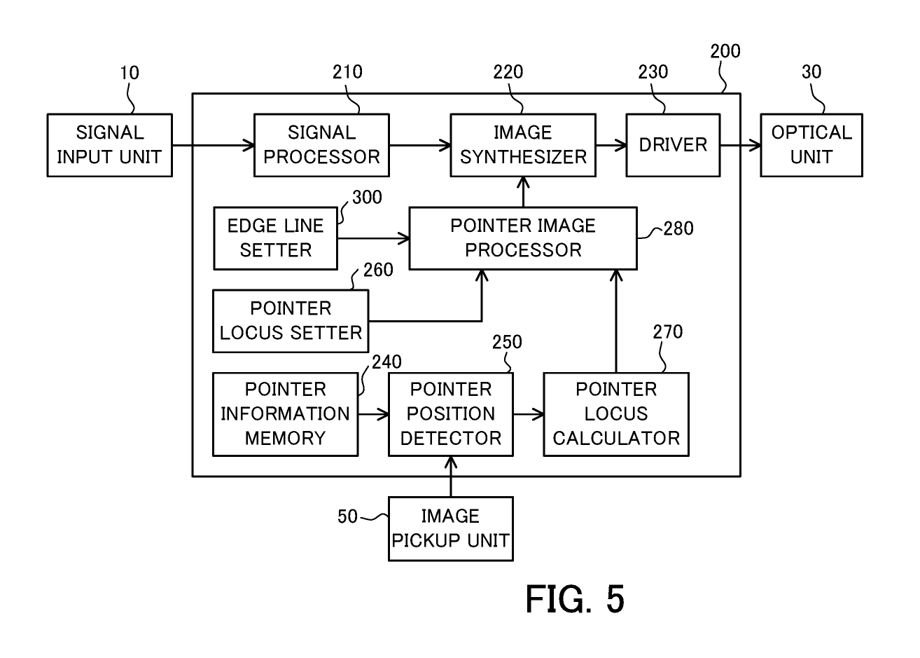

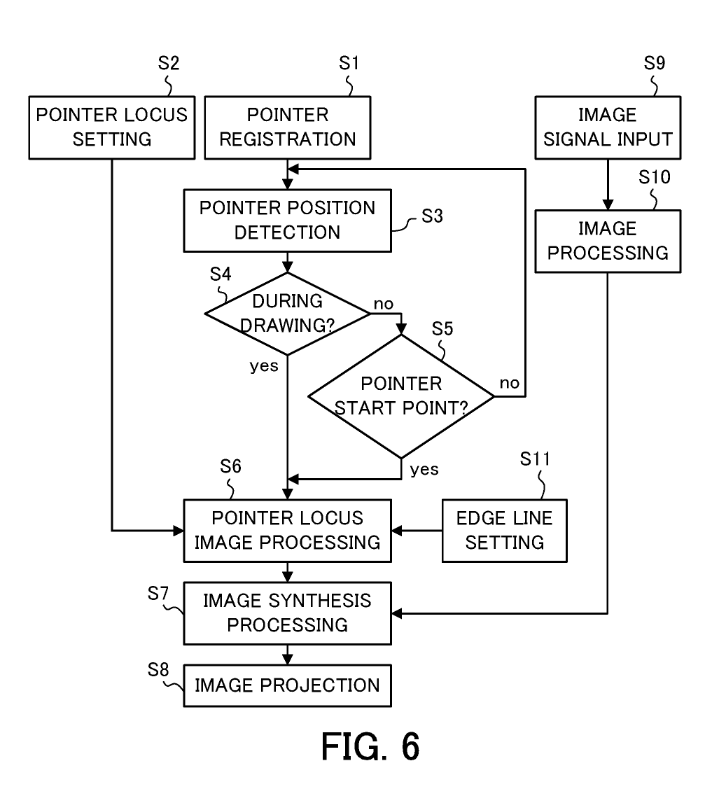

Next, referring to FIGS. 5 and 6, a configuration and an operation of the image processor 200 will be described. FIG. 5 is a block diagram of the image processor 200. FIG. 6 is a flowchart of illustrating processing by the image projection apparatus 100 including the image processor 200. Each step in FIG. 6 is performed mainly by each unit of the image processor 200.

As illustrated in FIG. 5, the image processor 200 includes a signal processor 210, an image synthesizer 220, and a driver 230. The image processor 200 further includes a pointer information memory 240, a pointer position detector 250, a pointer locus setter 260, a pointer locus calculator 270, a pointer image processor 280, and an edge line setter 300.

At step S9 in FIG. 6, an image signal is input from an external apparatus to the signal input unit 10. Subsequently, at step S10, the signal processor 210 converts a display format of the input image signal into a panel display format, and it performs frame rate conversion and image processing such as various adjustments of a quality of an image and a correction of the image.

At step S1, the image processor 200 registers an intensity (luminance) or a shape of a point light 550 (indication light) emitted from the pointer 500 (pointer registration). For example, as illustrated in FIG. 3 (explanatory diagram of the pointer registration), the image projection apparatus 100 projects a pointer registration area 510 constituting a part of the projected image 400 onto the projected surface 600. The user uses the pointer 500 to illuminate the point light 550 emitted from the pointer 500 onto the pointer registration area 510. Then, the image pickup unit 50 takes an image on the pointer registration area 510 (projected surface 600 including the pointer registration area 510) and analyzes the imaging data included in the pointer registration area 510 to acquire pointer information. The pointer information is the intensity (luminance) of the point light 550 or the shape of the point light 550 if it has a feature of the shape. The pointer information memory 240 (pointer information storage unit) stores (registers) the pointer information acquired through the image pickup unit 50.

In this embodiment, if it is difficult to illuminate the point light 550 as non-visible light onto the pointer registration area 510, it is preferred that the user approaches to the projected surface 600 to perform the pointer registration. Alternatively, the image projection apparatus 100 may be configured to display a predetermined message to notify the user when the point light 550 is illuminated within a range of the pointer registration area 510. In this embodiment, the image projection apparatus 100 projects the pointer registration area 510 on a part of the projected image 400, but this embodiment is not limited thereto. In other words, the pointer information can be acquired by illuminating the point light 550 within a range where the image pickup unit 50 can take an image on the projected surface 600 projected by the image projection apparatus 100 without projecting the pointer registration area 510.

At step S2, the pointer locus setter 260 performs parameter setting of a locus of the point light 550 projected by the image projection apparatus 100 (pointer locus setting). Specifically, the pointer locus setter 260 sets parameters such as hue, saturation, brightness (lightness), thickness (width), and shape like a solid line or a dashed line of each line of the point light 550 (pointer locus). These parameters can be set manually by the user or automatically by the image projection apparatus 100 (image processor 200). The pointer locus setter 260 stores (registers) the set parameters (set values).

Subsequently, at step S3, the pointer position detector 250 (position detector) detects a position (pointer position) of the point light illuminated by the pointer 500 on the projected surface 600. The pointer position is detected based on the imaging data from the image pickup unit 50 and the pointer information registered in the pointer information memory 240. The pointer position detector 250 compares information relating to the intensity or the shape of the point light from the pointer information memory 240 with information from the imaging data acquired by the image pickup unit 50. Then, the pointer position detector 250 determines whether or not there is the point light (i.e., whether or not an area being detected on the projected surface 600 is the point light) based on a result of the comparison.

Subsequently, at step S4, the pointer position detector 250 determines whether or not the pointer locus is being drawn. When the pointer locus is not being drawn, the flow proceeds to step S5. At step S5, the pointer position detector 250 confirms a start point of the pointer 500 (pointer start confirmation). Specifically, the pointer position detector 250 confirms whether or not the pointer position is detected continuously during a predetermined time. When the point light is illuminated instantaneously (i.e., when the pointer position which exists continuously during the predetermined time is not detected), the image processor 200 does not start drawing the pointer locus.

On the other hand, when the pointer position is detected continuously during the predetermined time (for example, for one second), the flow proceeds to step S6. At step S6, the pointer locus calculator 270 (locus calculator) calculates a pointer locus, and the image processor 200 starts drawing the pointer locus. In this embodiment, an output signal from the pointer locus calculator 270 is input to the pointer image processor 280. At step S11, the edge line setter 300 sets an edge line (parameters such as a color and a thickness of the edge line). The parameters set by the edge line setter 300, as well as the parameters set by the pointer locus setter 260, are input to the pointer image processor 280. The pointer image processor 280 performs image processing on the pointer locus according to the parameters such as a color and a thickness of the locus line of the point light, and a line type of a solid line or a dashed line set by the pointer locus setter 260. Furthermore, the pointer image processor 280 performs image processing on the edge line according to the parameters such as a color and a thickness of the edge line set by the edge line setter 300.

Hereinafter, the locus of the point light (pointer locus) and the edge line will be described. In FIG. 1, a pointer locus 530 (dark gray) and an edge line 540 (light gray) are drawn on the projected surface 600. The pointer locus 530 represents a locus that is drawn by point light previously illuminated by the pointer 500 onto the projected surface 600 with respect to a current pointer illumination position 520. Accordingly, when the user draws a character, a symbol, or an arbitrary shape on the projected surface 600 by using the pointer 500, the image projection apparatus 100 draws the locus of the point light as a pointer locus.

In order to show an effect of the edge line 540, the color of the projected image 400 and the color of the pointer locus 530 are the same dark gray each other. If the edge line 540 does not exist, the pointer locus 530 is buried in the projected image 400 and accordingly it is difficult to identify the pointer locus 530. On the other hand, if the edge line 540 that edges the pointer locus, as well as the pointer locus 530, is drawn, the projected image 400 and the pointer locus 530 are clearly separated from each other by the edge line 540, and accordingly both of them can be easily identified even in the same color. The color attributes (such as hue, saturation, and brightness) of the edge line set by the edge line setter 300 is different from the color attributes (such as hue, saturation, and brightness) set by the pointer locus setter 260, respectively. The thickness of the edge line is set manually by the user or automatically by the image projection apparatus 100 according to a thickness of the line of the pointer locus set by the pointer locus setter 260.

Subsequently, at step S7, the image synthesizer 220 synthesizes (combines) the signal (image signal) from the signal processor 210 with the signal (signal relating to the pointer locus) from the pointer image processor 280 to output a synthesized signal to the driver 230 (drive circuit). The driver 230 drives the optical modulation element of the optical unit 30 based on the synthesized signal (combined signal). Then, at step S8, the optical unit 30 generates an image, and the projection unit 40 magnifies the image to project the projected image 400 (magnified image) on the projected surface 600.

In this embodiment, the image processing circuit (image processor 200) performs the image processing so that an image indicating an illumination position of indication light (point light) from an indicator (pointer) on the projected surface as an indication signal indicating the illumination position of the indication light and an image obtained based on the image signal are separated from each other on the projected surface based on imaging data of the projected image obtained while the indication light from the indicator is illuminated onto the projected surface. Preferably, the image processor generates, as the indication signal, a locus of the indication light (pointer locus) on the projected surface and an edge line having a color attribute different from a color attribute of the locus. More preferably, the image processor includes a position detector (pointer position detector 250) that detects the illumination position of the indication light based on the imaging data, and a locus calculator (pointer locus calculator 270) that calculates the locus of the indication light based on a signal output from the position detector. More preferably, the image processor includes an image synthesizing circuit (image synthesizer 220) that synthesizes the locus of the indication light with the image signal to output a synthesized signal (combined signal). Then, the optical device (optical unit 30) generates the image based on the synthesized signal. The color attribute includes at least one of hue, saturation, and brightness (lightness).

As described above, even when the color of the image signal (input image) and the color of the indication light (pointer locus) are similar to each other, an image is projected while the input image and the pointer locus are separated from each other by the edge line, and therefore the input image and the pointer locus can be easily identified. According to this embodiment, an image projection apparatus and an image projection system which are capable of easily identifying a position of indication light (pointer locus) illuminated by an indicator (pointer) can be provided.

### Embodiment 2

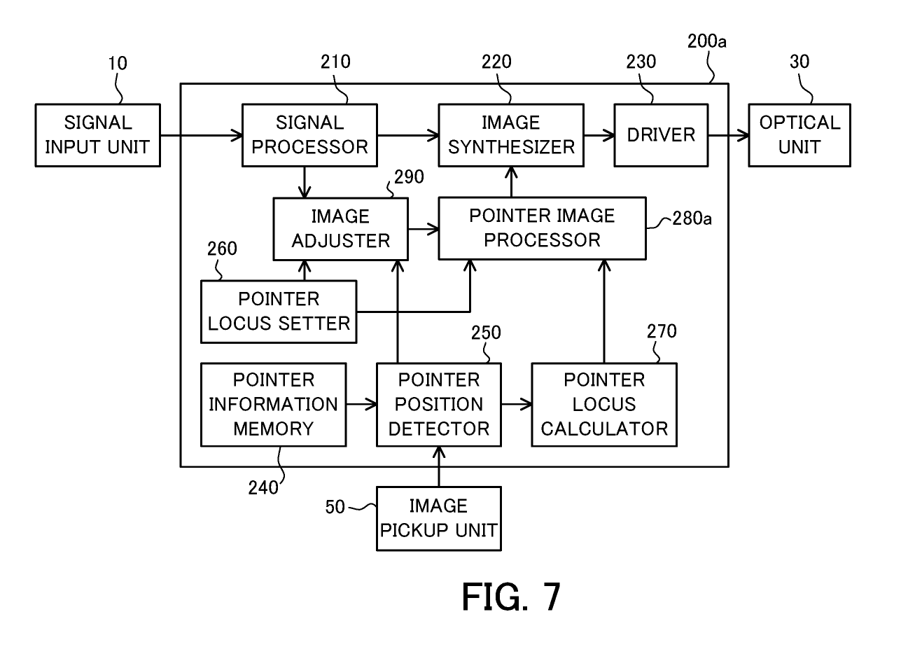

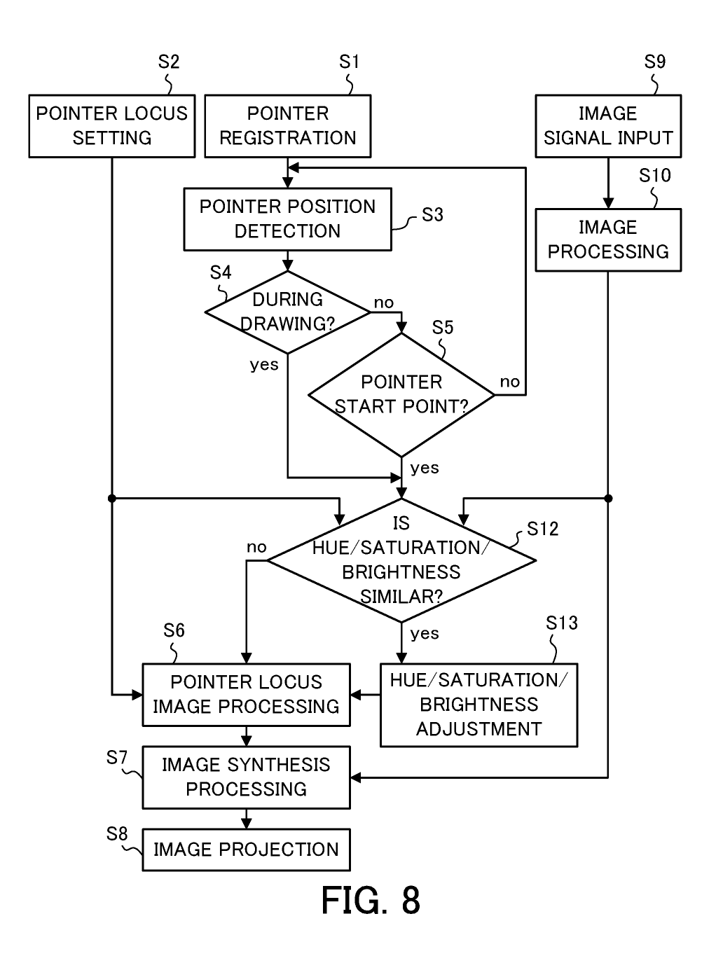

Next, referring to FIGS. 7 and 8, a configuration and an operation of an image processor 200a in Embodiment 2 of the present invention will be described. FIG. 7 is a block diagram of the image processor 200a. FIG. 8 is a flowchart of illustrating processing by an image projection apparatus 100 including the image processor 200a. Each step in FIG. 8 is performed mainly by each unit of the image processor 200a.

The image processor 200a illustrated in FIG. 7 is different from the image processor 200 of Embodiment 1 in that the image processor 200a includes a pointer image processor 280a and an image adjuster 290 instead of the pointer image processor 280 and the edge line setter 300. Other configurations of the image processor 200a are the same as those of the image processor 200 in Embodiment 1, and accordingly descriptions thereof are omitted. Processing of this embodiment illustrated in FIG. 8 is different from the processing of Embodiment 1 in that the processing of this embodiment includes steps (steps S12 and S13) of comparing and adjusting a color attribute (such as hue, saturation, and brightness) instead of a step (step S11) of performing the edge line setting. Other steps of the processing in this embodiment are the same as those in Embodiment 1, and accordingly descriptions thereof are omitted.

At step S4 in FIG. 8, when the pointer position detector 250 determines that the pointer locus is being drawn, the flow proceeds to step S12. At step S12, the image adjuster 290 acquires the hue, the saturation, and the brightness of the image signal processed by the signal processor 210 at step S10 with respect to the pointer position detected by the pointer position detector 250 at step S3. Furthermore, the image adjuster 290 acquires the hue, the saturation, and the brightness of the point light set by the pointer locus setter 260 at step S2. Then, the image adjuster 290 compares the hue, the saturation, and the brightness of the image signal with the hue, the saturation, and the brightness of the point light, respectively. When the image adjuster 290 determines that the color attribute (at least one of the hue, the saturation, and the brightness) of the image signal and the color attribute (at least one of the hue, the saturation, and the brightness) of the point light are not similar to each other, the flow proceeds to step S6.

On the other hand, when the image adjuster 290 determines that the color attribute of the image signal and the color attribute of the point light are similar to each other, the flow proceeds to step S13. At step S13, the image adjuster 290 adjusts the color attribute (at least one of the hue, the saturation, and the brightness) of the point light set at step S2. In other words, the image adjuster 290 changes the color attribute of the point light so that the color attribute of the point light is not similar to the color attribute of the image signal. As a result, the projected image can be generated while the input image (image signal) and the point light are separated from each other. For example, if the hue of the image signal at the pointer position is red and the hue of the point light is also red, the color attribute of the point light is changed to a color other than red (another color that is not similar to red). In this case, the changed color is set to blue or green, but this embodiment is not limited thereto. The changed color may yellow, and any color may be adopted as long as it can be identified in red as the hue of the image signal. In addition to the change of the hue, a vividness of the color, that is, saturation, or the brightness, that is, the lightness may be changed. Since a color comes close to gray with decreasing the saturation while the hue is the same color, the saturation may be changed without changing the hue. Similarly, since the color comes close to white with increasing the brightness and it comes close to black with decreasing the brightness while the hue is the same color, the saturation may be changed without changing the hue.

In this embodiment, the image processing circuit (image processor 200a) determines whether or not the color attribute of the image signal and the color attribute of the indication signal are similar to each other with respect to the illumination position of the indication light. When the image processing circuit determines that the color attributes are similar to each other, it changes the color attribute of the indication signal so as not to be similar to the color attribute of the image signal. Preferably, the image processing circuit determines that the color attribute of the image signal and the color attribute of the indication signal are similar to each other when a similarity of the color attributes is higher than a predetermined threshold value. On the other hand, the image processing circuit determines that the color attributes are not similar to each other when the similarity of the color attributes is lower than the predetermined threshold value. More preferably, the image processing circuit uses an average value relating to an area including the illumination position of the indication light in a predetermined time period to determine the similarity. In other words, it is determined whether or not the similarity is high within a range of a predetermined area during the predetermined time period, instead of a similarity with respect to an instantaneous specific position, and accordingly a frequency of the change of the color of the indication signal cannot be too high. The color attribute includes at least one of the hue, the saturation, and the brightness.

As described above, when the color of the image signal (input image) and the color of the indication light (pointer locus) are similar to each other, the attribute (such as hue, saturation, and brightness) of the pointer locus is changed, and therefore the input image and the pointer locus can be easily identified. According to this embodiment, an image projection apparatus and an image projection system which are capable of easily identifying a position (pointer locus) of point light (indication light) illuminated by an indicator (pointer) can be provided.

### Embodiment 3

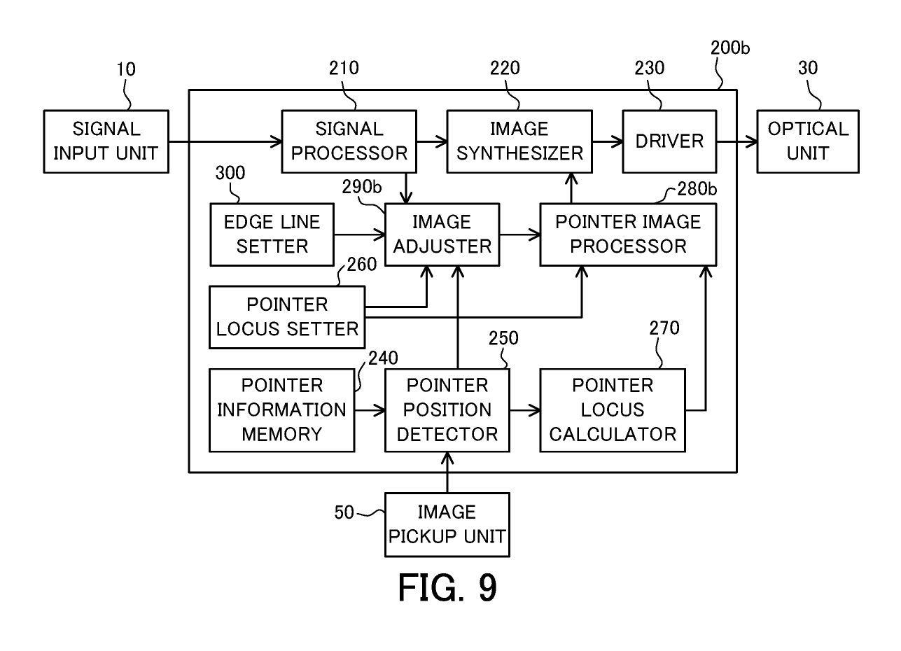

Next, referring to FIG. 9, a configuration and an operation of an image processor 200b in Embodiment 3 of the present invention will be described. FIG. 9 is a block diagram of the image processor 200b.

The image processor 200b of this embodiment is different from the image processor 200 of Embodiment 1 in that the image processor 200b includes a pointer image processor 280b and an image adjuster 290b instead of the pointer image processor 280. Other configurations of the image processor 200b are the same as those of the image processor 200 in Embodiment 1, and accordingly descriptions thereof are omitted.

Similarly to the image adjuster 290 in Embodiment 2, the image adjuster 290b acquires hue, saturation, and brightness (lightness) of an image signal processed by the signal processor 210 with respect to a pointer position detected by the pointer detector 250. Furthermore, it acquires hue, saturation, and brightness (lightness) of point light set by the pointer locus setter 260. Then, it compares the hue, the saturation, and the brightness of the image signal with the hue, the saturation, and the brightness of the point light, respectively.

When the image adjuster 290b determines that a color attribute of the image signal and a color attribute of the point light are similar to each other, it generates an edge line set by the edge line setter 300. Similarly to Embodiment 1, the edge line setter 300 performs setting so that the hue, the saturation, or the brightness of the edge line is different from the hue, the saturation, or the brightness set by the pointer locus setter 260, respectively.

In this embodiment, the image processing circuit (image processor 200b) generates, as an indication signal, a locus (pointer locus) of the indication light on the projected surface. Furthermore, the image processing circuit determines whether or not the color attribute of the image signal and the color attribute of the locus are similar to each other with respect to an illumination position of the indication light. When the image processing circuit determines that the color attributes are similar to each other, it generates the edge line having a color attribute which is different from the color attribute of the locus.

As described above, when the color of the image signal (input image) and the color of the indication light (pointer locus) are similar to each other, the edge line is generated on the pointer locus to separate the input image and the pointer locus from each other, and therefore the input image and the pointer locus can be easily identified. According to this embodiment, an image projection apparatus and an image projection system which are capable of easily identifying a position (pointer locus) of indication light illuminated by an indicator (pointer) can be provided.

### Embodiment 4

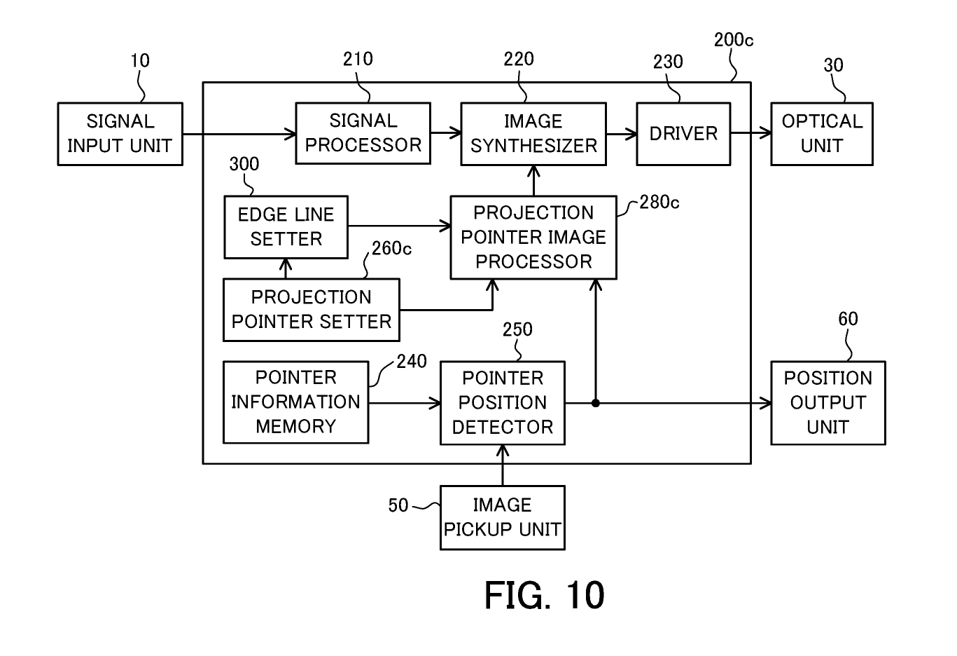

Next, referring to FIG. 10, a configuration and an operation of an image processor 200c in Embodiment 4 of the present invention will be described. FIG. 10 is a block diagram of the image processor 200c.

The image processor 200c of this embodiment is different from the image processor 200 of Embodiment 1 in that the image processor 200c includes a projection pointer setter 260c and a projection pointer image processor 280c instead of the pointer locus setter 260, the pointer locus calculator 270, and the pointer image processor 280. Other configurations of the image processor 200c are the same as those of the image processor 200 in Embodiment 1, and accordingly descriptions thereof are omitted. The image projection apparatus of this embodiment is different from the image projection apparatus 100 of Embodiment 1 in that the image projection apparatus of this embodiment includes a position output unit 60. This embodiment is different from each of Embodiments 1 to 3 in that this embodiment draws a projected pointer at a position of point light that is currently illuminated by a pointer instead of drawing the locus of the point light.

The position output unit 60 outputs a position (pointer position) of the point light, which is detected by the pointer position detector 250, illuminated by the pointer 500 onto the projected surface 600. The signal output from the position output unit 60 is input to an external apparatus such as a computer (not illustrated). The computer also generates an input image (image signal) to the signal input unit 10. The input image from the computer includes an operation image that receives an instruction operation to the computer, in addition to a typical image signal (video signal). For example, the operation image is an image where a plurality of operation can be selected to change the setting of the signal to the signal input unit 10, such as stopping the video, forwarding to the next video, reversing the image, and a size and a hue of the image. When the point light by the pointer 500 is illuminated on the projected operation image and the position of the point light is input to the computer through the position output unit 60, the computer identifies the operation image according to the position of the point light to perform the selected operation.

The projection pointer setter 260c performs parameter setting of the projected pointer that is to be projected by the image projection apparatus 100. Specifically, the projection pointer setter 260c sets parameters such as hue, saturation, brightness, and shape of the projected pointer. These parameters are set manually by the user or automatically by the image projection apparatus. The shape of the projected pointer is for example “∘” (circle), “□” (square), “Δ” (triangle), or “⋆” (star), but this embodiment is not limited thereto. These parameters (set values) are registered and stored in the projection pointer setter 260c. Similarly to Embodiment 1, the hue, the saturation, or the brightness of the edge line set by the edge line setter 300 is different from the hue, the saturation, or the brightness set by the projection pointer setter 260c. The thickness of the edge line is set manually by the user or automatically by the image projection apparatus with respect to the shape set through the pointer 500.

The projection pointer image processor 280c performs image processing to draw a projected pointer position on a position of the point light currently illuminated by the pointer according to the signal output from the projection pointer setter 260c and the signal output from the pointer position detector 250. In other words, the projection pointer image processor 280c generates a projected pointer. Then, the projection pointer image processor 280c generates the edge line for the generated projected pointer according to the signal output from the edge line setter 300. The image synthesizer 220 synthesizes the input image with the projected pointer and the edge line. The driver 230 and the optical unit 30 magnifies the image to be projected onto the projected surface.

In this embodiment, the image processing circuit (image processor 200c) generates, as an indication signal, an index (projection pointer) that indicates a current position of the indication light on the projected surface and an edge line that has a color attribute different from a color attribute of the index.

As described above, even when the color of the image signal (input image) and the color of the indication light on the illumination position (projected pointer) are similar to each other, an image is projected while the input image and the projected pointer are separated from each other by the edge line, and therefore the input image and the projected pointer can be easily identified. According to this embodiment, an image projection apparatus and an image projection system which are capable of easily identifying the position (projected pointer) of indication light illuminated by an indicator (pointer) can be provided.

### Embodiment 5

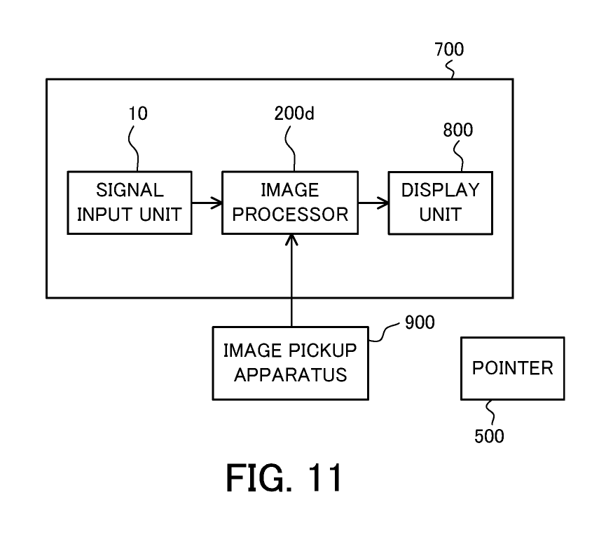

Next, referring to FIG. 11, Embodiment 5 of the present invention will be described. This embodiment relates to a display apparatus (display system) having a feature in any of Embodiments 1 to 4. In other words, this embodiment applies the feature in any of Embodiments 1 to 4 to the display apparatus (display system) instead of the image projection apparatus (image projection system).

FIG. 11 is a block diagram of a display apparatus 700 (monitor) in this embodiment. The display apparatus 700 includes a signal input unit 10 (input circuit), an image processor 200d (image processing circuit), and a display unit 800 (display circuit). The signal input unit 10 input an image signal. The image processor 200d performs image processing on the image signal, and it has the same functions as those in any of the image processors 200, 200a, 200b, and 200c in Embodiments 1 to 4. The display unit 800 displays an image on a display surface based on a signal output from the image processor 200d.

A pointer 500 (indicator) is provided outside the display apparatus 700. The pointer 500 illuminates point light (indication light) onto the display surface. In this embodiment, an image pickup apparatus 900 (image pickup unit) as an external camera is provided outside the display apparatus 700.

The image pickup apparatus 900 acquires imaging data of an image while the point light is illuminated onto the display surface. In this embodiment, the display apparatus 700, the pointer 500, and the image pickup apparatus 900 constitute a display system. The image processor 200d performs the image processing so that an indication signal indicating an illumination position of the point light is separated from the image signal based on the imaging data.

According to this embodiment, a display apparatus and a display system which are capable of easily identifying a position of indication light illuminated by an indicator can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-139550, filed on Jul. 13, 2015, which is hereby incorporated by reference herein in its entirety.

What is claimed is:

1. An image projection apparatus comprising:
an input unit configured to input an image signal;
an image processor configured to perform image processing on the image signal;
an optical unit configured to generate an image based on a signal output from the image processor by using light from a light source unit; and
a projection unit configured to project the image as a projected image onto a projected surface,
wherein the image processor is configured to perform the image processing so that an image indicating an illumination position of indication light from an indicator on the projected surface as an indication signal indicating the illumination position of the indication light and an image obtained based on the image signal are separated from each other on the projected surface based on imaging data of the projected image obtained while the indication light from the indicator is illuminated onto the projected surface.

2. The image projection apparatus according to claim 1, wherein the image processor is configured to generate, as the indication signal, a locus of the indication light on the projected surface and an edge line having a color attribute different from a color attribute of the locus.

3. The image projection apparatus according to claim 2, wherein the image processor includes:
a position detector configured to detect the illumination position of the indication light based on the imaging data, and
a locus calculator configured to calculate the locus of the indication light based on a signal output from the position detector.

4. The image projection apparatus according to claim 2, wherein:
the image processor includes an image synthesizer configured to synthesize the locus of the indication light with the image signal to output a synthesized signal, and
the optical unit is configured to generate the image based on the synthesized signal.

5. The image projection apparatus according to claim 1, wherein the image processor is configured to:
determine whether or not a color attribute of the image signal and a color attribute of the indication signal are similar to each other with respect to the illumination position of the indication light, and
change the color attribute of the indication signal so as not to be similar to the color attribute of the image signal when the color attributes of the image signal and the indication signal are similar to each other.

6. The image projection apparatus according to claim 5, wherein the image processor is configured to:
determine that the color attribute of the image signal and the color attribute of the indication signal are similar to each other when a similarity of the color attributes is higher than a predetermined threshold value, and
determine that the color attributes are not similar to each other when the similarity of the color attributes is lower than the predetermined threshold value.

7. The image projection apparatus according to claim 6, wherein the image processor is configured to use an average value relating to an area including the illumination position of the indication light in a predetermined time period to determine the similarity.

8. The image projection apparatus according to claim 1, wherein the image processor is configured to:
generate, as the indication signal, a locus of the indication light on the projected surface,
determine whether or not a color attribute of the image signal and a color attribute of the locus are similar to each other with respect to the illumination position of the indication light, and
generate an edge line having a color attribute different from the color attribute of the locus when the color attributes of the image signal and the locus are determined to be similar to each other.

9. The image projection apparatus according to claim 1, wherein the image processor is configured to generate, as the indication signal, an index indicating a current position of the indication light on the projected surface and an edge line having a color attribute different from a color attribute of the index.

10. The image projection apparatus according to claim 2, wherein the color attribute includes at least one of hue, saturation, and brightness.

11. An image projection system comprising:
an input unit configured to input an image signal;
an image processor configured to perform image processing on the image signal;
an optical unit configured to generate an image based on a signal output from the image processor by using light from a light source unit; and
a projection unit configured to project the image as a projected image onto a projected surface,
an indicator configured to illuminate indication light onto the projected surface; and
an image pickup unit configured to acquire imaging data of the projected image while the indication light is illuminated onto the projected surface,
wherein the image processor is configured to perform the image processing so that an image indicating an illumination position of indication light from an indicator on the projected surface as an indication signal indicating the illumination position of the indication light and an image obtained based on the image signal are separated from each other on the projected surface.

12. The image projection system according to claim 11, wherein the indicator is configured to illuminate non-visible light as the indication light onto the projected surface.

13. A display apparatus comprising:
an input unit configured to input an image signal;
an image processor configured to perform image processing on the image signal; and
a display unit configured to display an image on a displayed surface based on a signal output from the image processor,
wherein the image processor is configured to perform the image processing so that an image indicating an illumination position of indication light from an indicator on the displayed surface as an indication signal indicating the illumination position of the indication light and an image obtained based on the image signal are separated from each other on the displayed surface based on imaging data of the projected image obtained while the indication light from the indicator is illuminated onto the displayed surface.

14. A display system comprising:
an input unit configured to input an image signal;
an image processor configured to perform image processing on the image signal; and
a display unit configured to display an image on a displayed surface based on a signal output from the image processor,
an indicator configured to illuminate indication light onto the displayed surface; and
an image pickup unit configured to acquire imaging data of the image while the indication light is illuminated onto the displayed surface,
wherein the image processor is configured to perform the image processing so that an image indicating an illumination position of indication light from an indicator on the displayed surface as an indication signal indicating the illumination position of the indication light and an image obtained based on the image signal are separated from each other on the displayed surface based on the imaging data.
